(19) United States
(12) Patent Application Publication
(10) Pub. No.: US 2025/0320118 A1
(43) Pub. Date: Oct. 16, 2025

(54) STEAM SULFUROUS MATERIAL REFORMING AND THERMOCHEMICAL CYCLES RELATED THERETO

(71) Applicant: Peregrine Hydrogen Inc., Santa Cruz, CA (US)

(72) Inventors: Sam Faucher, Santa Cruz, CA (US); Matthew Shaner, Santa Cruz, CA (US); Ian McKay, Santa Cruz, CA (US)

(73) Assignee: Peregrine Hydrogen Inc., Santa Cruz, CA (US)

(21) Appl. No.: 19/177,307

(22) Filed: Apr. 11, 2025

Related U.S. Application Data
(60) Provisional application No. 63/633,531, filed on Apr. 12, 2024.

(51) Int. Cl. C01B 3/10; B01D 53/22; B01D 71/02; C01B 3/50; C01B 17/02; C01B 17/50; C01B 17/56; C01B 17/74

(52) U.S. Cl. CPC C01B 3/105; B01D 53/228; B01D 71/02231; C01B 3/505; C01B 17/02; C01B 17/508; C01B 17/56; C01B 17/74; B01D 2256/16; B01D 2257/80; C01B 2203/0405; C01B 2203/0495

(57) ABSTRACT

A method can include performing a series of reactions in a closed cycle, the series of reactions consisting of a hydrolysis reaction where a redox reagent is oxidized to a corresponding oxidized redox reagent with water contemporaneously with the production of hydrogen; and a reduction reaction where the oxidized redox reagent is reduced to the redox reagent using a sulfurous reactant contemporaneously with production of sulfur dioxide.

### CROSS-REFERENCE TO RELATED APPLICATIONS

This application claims the benefit of U.S. Provisional Application No. 63/633,531 filed 12 Apr. 2024, which is incorporated in its entirety by this reference.

### TECHNICAL FIELD

This invention relates generally to the hydrogen production field, and more specifically to a new and useful method and thermochemical cycles in the hydrogen production field.

### BRIEF DESCRIPTION OF THE FIGURES

FIG. 1 is a schematic representation of a variant of the method.

FIG. 2 is an illustrative example of a variant of the method.

FIG. 3 is an illustrative example of a variant of the method.

FIG. 4 is an illustrative example of a variant of a sulfur cycle.

FIG. 5 is an illustrative example of a variant of a sulfur cycle.

FIG. 6 is an illustrative example of a variant of a thermochemical cycle.

FIG. 7 is an illustrative example of a variant of the method.

FIG. 8 is an illustrative example of a variant of the method.

FIG. 9 is an illustrative example of a variant of the method.

FIG. 10 is an illustrative example of a variant of the two-step reaction.

### DETAILED DESCRIPTION

The following description of the embodiments of the invention is not intended to limit the invention to these embodiments, but rather to enable any person skilled in the art to make and use this invention.

### 1. Overview

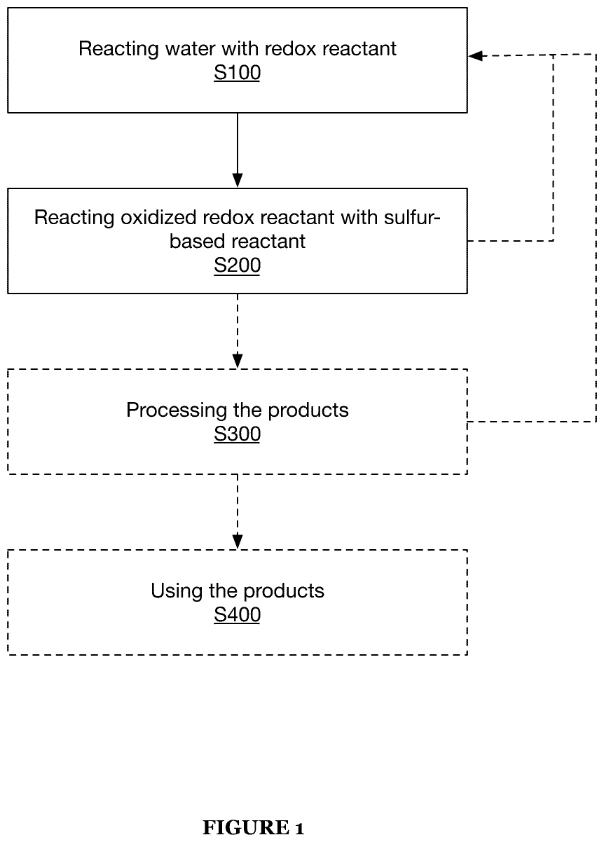

As shown in FIG. 1, the method can include: performing a hydrolysis reaction (e.g., reacting water with a redox reactant) S100; reacting the oxidized redox reactant with a sulfurous reactant S200; processing the products S300; and using products S400. The method preferably functions to produce SO₂ and hydrogen gas. However, the method can additionally or alternatively form other sulfurous species (e.g., sulfur, sulfuric acid, oleum, etc.) and/or be used to form other downstream products (e.g., using the sulfurous species, sulfur dioxide, and/or hydrogen in isolation or combination).

The method can include performing a thermochemical cycle in which a redox reactant cycles between oxidation and reduction (e.g., the redox reactant can be oxidized and subsequently reduced). The thermochemical cycle can be performed any number of iterations (e.g., by repeating oxidation and reduction of the redox reactant, by repeating S100, S200, and optionally S300). The thermochemical cycle can be performed with the same redox reactant until it is substantially degraded (e.g., redox reagent particles no longer undergo reduction to the original redox reagent material, mass of the redox reagent decreases such as through sublimation by greater than about 20%, etc.).

### 2. Examples

In an illustrative example, a method can include performing a thermochemical cycle involving: using water to oxidize a redox reactant (e.g., a metal such as iron, zinc, tin, cerium, copper, manganese, vanadium, nickel, titanium, chromium, cobalt, combinations thereof, etc.), producing hydrogen; reducing the oxidized reactant with a sulfurous reactant, producing sulfur dioxide and regenerating the redox reactant; and repeating the reactions to continue producing SO₂ and H₂. The method can include steps such as separating inert gas, separating water, and/or condensing sulfur to be reused in the thermochemical cycle. In variants, the method can include processing the resultant SO₂ into sulfuric acid using SO₂ disproportionation, contact processes, or sulfur depolarization electrolysis.

### 3. Technical Advantages

Variants of the technology can confer one or more advantages over conventional technologies.

First, variants of the technology can improve the efficiency of SO₂ and hydrogen production over conventional approaches. This efficiency can be achieved by leveraging thermochemical cycles to produce hydrogen and SO₂ from the cyclic oxidation and reduction of a redox reactant. In examples of this process, the redox reactant undergoes reversible transformations between different oxidation states, resulting in the continuous regeneration of the reactants, as well as reducing material cost and waste compared to methods that require constant supply of new reactants.

Second, variants of the technology can have reduced energy consumption. For example, variants of the technology include reducing an oxide with a sulfurous reactant to produce SO₂. This contrasts with other technologies which aim to reduce an oxide to produce O₂, which is a more energy intensive process (e.g., requires higher temperatures and is typically not a valuable product on its own). By producing SO₂ instead, variants of the technology can consume less energy (e.g., perform reactions at a lower temperature) than other hydrogen production methods while co-producing SO₂, a valuable gas used in applications like the production of sulfuric acid and as a reactant in various chemical processing industries.

Third, variants of the technology can be more energy efficient than other conventional methods by leveraging advanced heat integration strategies. For instance, variants of the technology can include capturing and recycling the heat generated from combusting sulfur and channeling this recovered thermal energy into key process steps, such as pre-heating reactants and powering thermal reactors. Additionally, variants of the technology can reduce heat waste by using heat resistant membranes that can filter steam from the produced gases to maintain the elevated temperatures of the water for re-use in the thermochemical reaction. Variants of the technology that efficiently use heat not only reduce the need for external energy inputs but can also improve the overall thermodynamic performance of the process, leading to a more sustainable and cost-effective production method.

However, further advantages can be provided by the system and method disclosed herein.

### 4. Method

As shown in FIG. 1, the method can include: performing a hydrolysis reaction (e.g., reacting water with a redox reactant) S100; reacting the oxidized redox reactant with a sulfurous reactant S200; processing the products S300; and using products S400. The method preferably functions to produce SO₂ and hydrogen gas. However, the method can additionally or alternatively form other sulfurous species (e.g., sulfur, sulfuric acid, oleum, etc.) and/or be used to form other downstream products (e.g., using the sulfurous species, sulfur dioxide, and/or hydrogen in isolation or combination such as fertilizer, ammonia, metals, etc.).

The method can include performing a thermochemical cycle in which a redox reactant cycles between oxidation and reduction (e.g., the redox reactant can be oxidized and subsequently reduced). The thermochemical cycle can be performed any number of iterations (e.g., by repeating oxidation and reduction of the redox reactant, by repeating S100, S200, and optionally S300). The thermochemical cycle can be performed with the same redox reactant until it is substantially degraded (e.g., redox reagent particles no longer undergo reduction to the original redox reagent material, mass of the redox reagent decreases such as through sublimation by greater than about 20%, etc.).

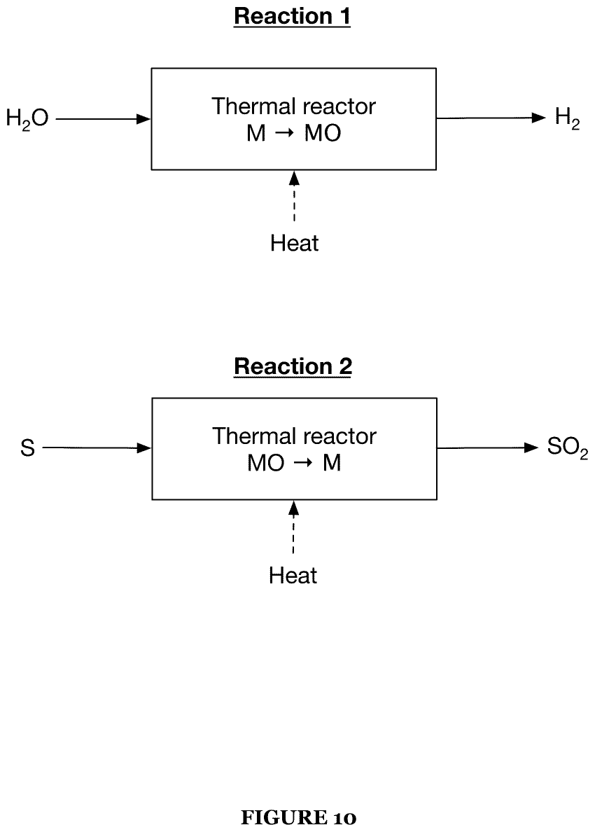

The method can be performed as a two-step reaction as shown in FIG. 10. The method can alternatively be performed using any suitable number of steps (e.g., three-step reaction, four-step reactions, etc.).

In one variant, the method (e.g., S100 and S200 thereof) can result in an overall reaction: S+2H₂→SO₂+2H₂. In a second variant, the method can result in the net reaction: 2H₂S→2H₂+S₂. In a third variant, the method can result in the net reaction: H₂S+2H₂O→3H₂+SO₂. In a fourth variant, the preceding three variants can be combined in any suitable ratio (e.g., to tune the resulting SO₂ to H₂ concentration), where these variants can be performed in the same reactor (e.g., based on a steam to sulfurous material ratio, based on a ratio of different sulfurous materials included, etc.) and/or in separate reactors (e.g., with combined output streams). The method can be performed in batches, continuously, and/or with any other timing.

The method can be performed by a thermal reactor or a set of thermal reactors. The thermal reactors can include a set of gas lines for introducing reactants and catalysts. The thermal reactors can be heated and/or pressurized. However, the method can be performed in any suitable reaction container.

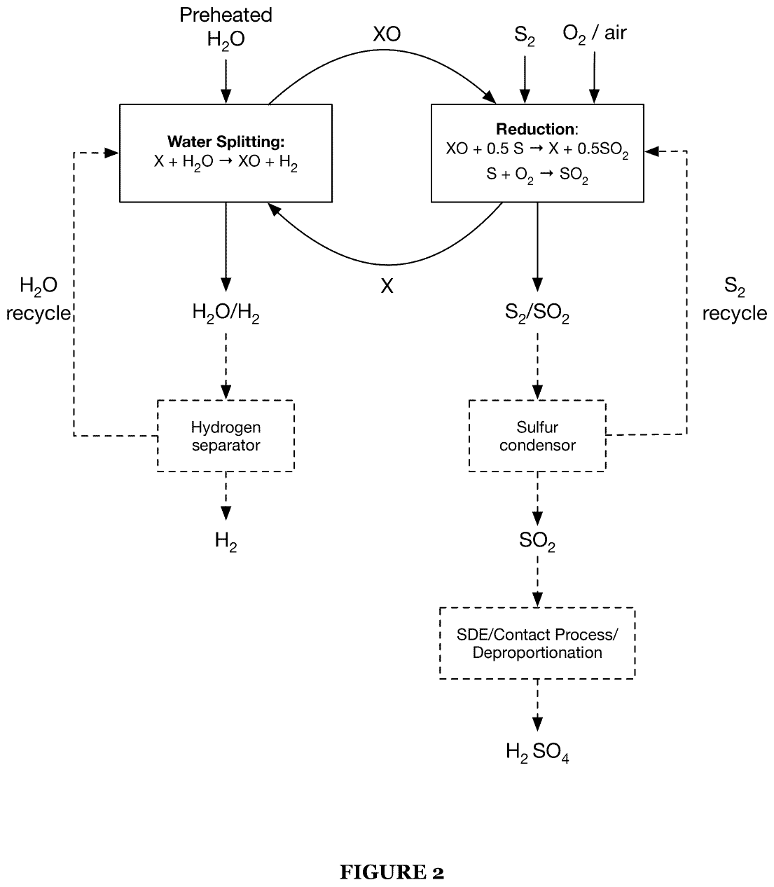

Performing a hydrolysis reaction (e.g., reacting water with a redox reactant) S100 functions to oxidize the redox reactant and produce hydrogen gas through a water splitting reaction, example shown in FIG. 2.

In one variant, S100 (e.g., reacting water with a redox reactant) can include performing the reaction X+yH₂O→XO_{y}+y/2H₂, where X can be the redox reactant and XO_{y} can be the oxidized redox reactant (where y may be an integer or a rational number depending on the stoichiometric ratio of oxygen to X in the oxidized redox reactant). In another variant (e.g., where hydrolysis can be more broadly interpreted as dehydrogenation of a chalcogenide), S100 can include performing the reaction X+yH₂S→XS_{y}+y/2H₂. In yet another variant, S100 can include a sulfidation reaction (e.g., X+yS→XS_{y}). In yet another variant, S100 can include performing the reaction represented by X+y/2SO₂→XO_{y}+y/2S. In another variant, a plurality of the aforementioned reactions can be performed substantially simultaneously (e.g., when a mixture of sulfurous reactants are used to oxidize the redox reactant).

The redox reactant can include iron, zinc, tin, cerium, copper, manganese, vanadium, nickel, iron, zinc, tin, cerium, copper, manganese, vanadium, titanium, chromium, cobalt, nickel, sulfur, perovskites, metal sulfides (e.g., using one of the aforementioned metals), metal suboxides (e.g., metal oxides such as using one or more of the aforementioned metals in an oxidation state of the metal is less than the oxidation state of the highest common or known metal oxide of that metal), and/or any other redox reactant. The redox reactant preferably is non-volatile and/or reacts into a non-volatile oxide at the hydrolysis temperature and/or reduction temperature (e.g., to minimize loss of the redox reactant through repetitions of the oxidation and reduction). For example, the redox reactant and its oxide can remain in a solid state and/or liquid state during the reaction. The redox reactant preferably has a geometry with a high surface area to volume ratio to maximize reaction rate (e.g., porous structures, mesh structures, honeycomb structures, nanoparticles, particulates, thin sheets, wires, etc.).

S100 (e.g., reacting water with a redox reactant) can be performed by introducing water (e.g. steam, etc.) and a redox reactant into a thermal reactor.

The hydrolysis reaction can be performed at temperatures between 400° C. and 800° C. or any range or value therebetween (e.g., 400°° C., 450° C., 500° C., 550° C., 600° C., 650°° C., 700° C., 750° C., 800° C., or any value therebetween) to drive the reaction to a preferred equilibrium and/or achieve a target reaction rate. The hydrolysis temperature can alternatively be less than 400° C. or greater than 800° C. (e.g., depending on the redox reactant used, pressures used, etc.). The reaction can be performed at pressures between 1 bar and 30 bar or any range or value therebetween (e.g., 1 bar, 2 bar, 3 bar, 4 bar, 5 bar, 6 bar, 7 bar, 8 bar, 9 bar, 10 bar, 15 bar, 20 bar, 25 bar, 30 bar, etc.). The pressure can alternatively be less than 1 bar or greater than 30 bar. For instance, high pressures (e.g. above 15 bar) can be used to increase the reaction rate and improve the efficiency of hydrogen production. The reaction can be performed with a residence and/or reaction time between 0.5 seconds and 20 seconds or any range or value therebetween (e.g., 0.5 seconds, 1 second, 2 seconds, 3 seconds, 4 seconds, 5 seconds, 10 second, 12 seconds, 15 seconds, 20 seconds, or any value therebetween) to ensure water-splitting reaction and oxidation occurs (e.g., to achieve a reaction efficiency greater than about 90%. The residence and/or reaction time can alternatively be less than 0.5 seconds or greater than 20 seconds.

Excess water (e.g., steam) is preferably provided in the reactor (e.g., to drive the water splitting reaction to completion). However, substoichiometric amounts of water could be used.

S100 (e.g., reacting water with a redox reactant) can include using a catalyst to increase reaction rate. The catalysts can function to lower the activation energy required to break water into hydrogen and oxygen and can thereby increase the reaction rate of the hydrolysis reaction. Exemplary catalysts can include platinum-based catalysts, molybdenum sulfide, tungsten carbide, nickel-based catalysts, ruthenium dioxide, iridium dioxide, cobalt-based catalysts (e.g., cobalt phosphate, etc.), manganese-based catalysts (e.g., manganese oxides, etc.), and/or any other catalysts.

S100 (e.g., reacting water with a redox reactant) can optionally include pre-heating the water (e.g., up to or in some instances above the hydrolysis temperature) prior to introduction to the thermal reactor. For example, the water can be pre-heated to any temperature between 100° C. and 800°° C. or any range or value therebetween (e.g., 200° C., 300° C., 400° C.). The water can alternatively be pre-heated to a temperature less than 100° C. or greater than 800° C.

However, performing a hydrolysis reaction (e.g., reacting water with a redox reactant) S100 may be otherwise performed.

Reacting the oxidized redox reactant with a sulfurous reactant S200 functions to produce sulfur and/or SO₂ and reduce the oxidized redox reactant (e.g., back to the redox reactant, to a substoichiometric oxide of the redox reactant, to an oxide with a lower oxygen stoichiometry than the oxidized redox reactant, etc.).

The sulfurous reactant preferably functions to reduce the oxidized redox reactant, but can additionally or alternatively function otherwise. The sulfurous reactant can include elemental sulfur, disulfur, hydrogen sulfide, a metal sulfide, carbon disulfide, carbonyl sulfide, mercaptans (or other organosulfur compounds), and/or any other sulfurous reactant.

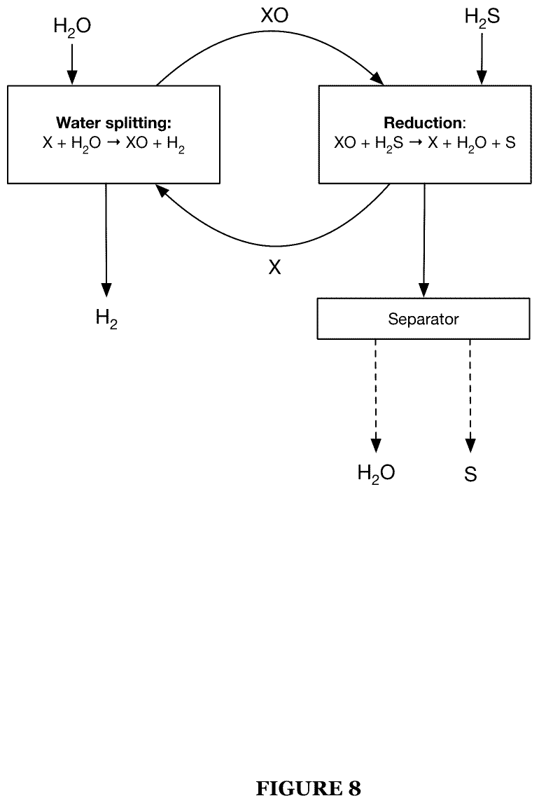

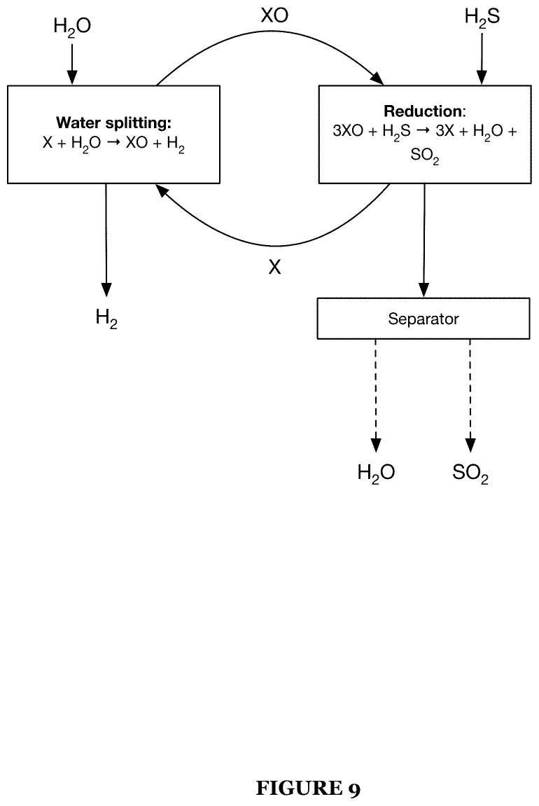

In a first variant, S200 can include performing the reaction: XO_{y}+y/2S→X+y/2SO₂. In a second variant, S200 can include performing the reaction: XO_{y}+yH₂S→X+yH₂O+yS, example shown in FIG. 8. In a third variant, S200 can include performing the reaction XO_{y}+y/3H₂S→X+y/3H₂O+y/3SO₂, example shown in FIG. 9. In a fourth variant, S200 can include performing the reaction XS_{y}+H₂→X+(y+1)S+H₂. In a fifth variant, S200 can include performing the reaction XO_{y}+y/2H₂→X+y/2H₂+y/2SO₂. In a sixth variant, S200 can include performing a combination of two or more of the reactions of the preceding five variants. Examples of the sixth variant generally consider the reactions occurring within the same reactor contemporaneously. However, the reactions could be performed sequentially (e.g., to form greater than 2reaction cycles). For instance, XS_{y} could undergo a displacement reaction to XO_{z} (where typically y and z will be the same value, but they do not have to have the same value) in the presence of a sulfurous reactant, where the XO_{z} can then be reduced to X by further sulfurous reactant.

In some variants of S200, oxygen (or other oxidizing agent such as N₂O, O₃, H₂O, H₂O₂, KMnO₄, etc.) can be introduced as a reactant within the thermal reactor, particularly for the purposes of local heat generation (e.g., by combustion of sulfur within the thermal reactor S+O₂→SO₂). The oxygen can be provided in substoichiometric amounts relative to sulfur, but can alternatively be provided in excess amounts. The substoichiometric amounts of oxygen relative to sulfur are preferred as these can minimize or avoid reoxidation of the redox reagent (e.g., metal cycling agent).

In some examples, the reaction in S200 can result in at least 50% of the sulfurous reactant by mass converting to SO₂ (e.g., 50%, 55%, 60%, 65%, 70%, 75%, 80%, 85%, 90%, 95%, 99%, 99.5%, 99.9%, 99.95%, 99.99%, 99.995%, 99.999%, 100%, or any value therebetween). However, any conversion rate can be achieved (e.g., by adjusting the reaction parameters such as pressure, temperature, reactants, reaction time, etc.). The conversion rate can be optimized by adjusting temperature, pressure, residence and/or reaction time, redox reactant geometry, implementing catalysts, and/or by varying any other optimization parameters.

S200 can be performed by introducing a sulfurous reactant (e.g., S₂, S, H₂S, metal sulfides, mercaptans, organosulfur compounds, carbon disulfide, carbonyl sulfide, etc.), gas (e.g., oxygen, air, inert gas, etc.), and the oxidized redox reactant into a thermal reactor. In variants, the thermal reactor can be the same thermal reactor used in S100 (e.g., where the oxidized redox reactant can remain within the thermal reactor between S100 and S200). For example, gas lines can be altered to flow in sulfurous reactant into reaction chamber (and hinder or prevent water from entering the thermal reactor) and new reaction parameters can be set (e.g. temperature, pressure, etc.). In other variants, the thermal reactor can be a different thermal reactor than the thermal reactor used in S100. For example, oxidized redox reactant can be transferred into a different thermal reactor configured for the reaction (e.g. different gas lines connected, different reaction parameters set, etc.).

In variants in which the same thermal reactor is used for both reactions, the thermal reactor is preferably evacuated between the reactions. Evacuating the thermal reactor can be performed by purging the reactor with inert gas (e.g., nitrogen, helium, neon, argon, krypton, etc.), using a vacuum pump to remove gases and/or vapors, cooling the reactor to condense reactants, draining and flushing the reactor, venting, and/or any other evacuation method. In particularly, some variants of S200 preferably do not include substantial amounts of water in the thermal reactor (e.g., water levels less than about 500 ppm), therefore evacuating the thermal reactor can remove residual water from within the thermal reactor. Evacuating the thermal reactor can additionally be beneficial for decreasing the temperature of the thermal reactor after the reduction reaction as the hydrolysis reaction is typically performed at lower temperatures.

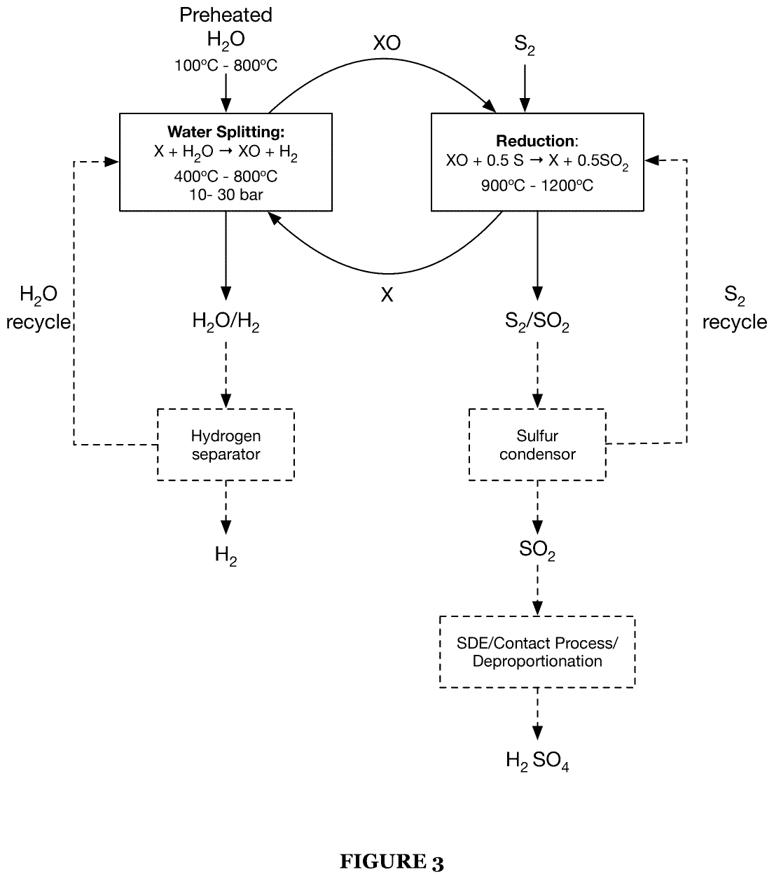

The reduction reaction can be performed at temperatures between 900° C. and 1500°° C. (e.g., 900° C., 950° C., 1000° C., 1050° C., 1100° C., 1150° C., 1200° C., 1250° C., 1300° C., 1350° C., 1400° C., 1450°° C., 1500° C., as shown for example in FIG. 3, etc.). The reaction can alternatively be performed at any suitable temperature. The temperature for the reduction reaction is preferably lower than that needed to reduce the oxidized redox reactant to produce O₂ (often around 2000° C. or greater). The reduction reaction can be performed at pressures between 1 bar and 50 bar (e.g., 1 bar, 2 bar, 3 bar, 4 bar, 5 bar, 6 bar, 7 bar, 8 bar, 9 bar, 10 bar, 15 bar, 20 bar, 25 bar, 30 bar, 35 bar, 40 bar, 45 bar, 50 bar, etc.). The reaction can alternatively be performed at any suitable pressure. In some examples, high pressures (e.g. above 15 bar) are found to increase the reaction rate and improve the efficiency of SO₂ production while minimizing cost. The reduction reaction can be performed with a residence and/or reaction time (e.g., an amount of time the sulfurous reactant is in the thermal reactor experiencing temperatures and/or pressures where the reduction reaction is expected to occur) between 0.01 seconds and 5 seconds (e.g., 0.01 seconds, 0.05 seconds, 0.1 seconds, 0.2 seconds, 0.3 seconds, 0.4 seconds, 0.5 seconds, 0.6 seconds, 0.7 seconds, 0.8 seconds, 0.9 seconds, 1 second, 2 seconds, 3 seconds, 5 seconds, etc.) to ensure sulfurous reactant has been substantially reacted. The reaction can alternatively be performed with any suitable residence and/or reaction time.

S200 can optionally include combusting sulfurous reactant prior to introduction into and/or within the thermal reactor. The heat and energy generated in combusting the sulfurous reactant can be used in other steps of the method (e.g., heating thermal reactor in S100, in processing steps in S300 like sulfur condensation, etc.).

However, reacting the oxidized redox reactant with a sulfurous reactant S200 may be otherwise performed.

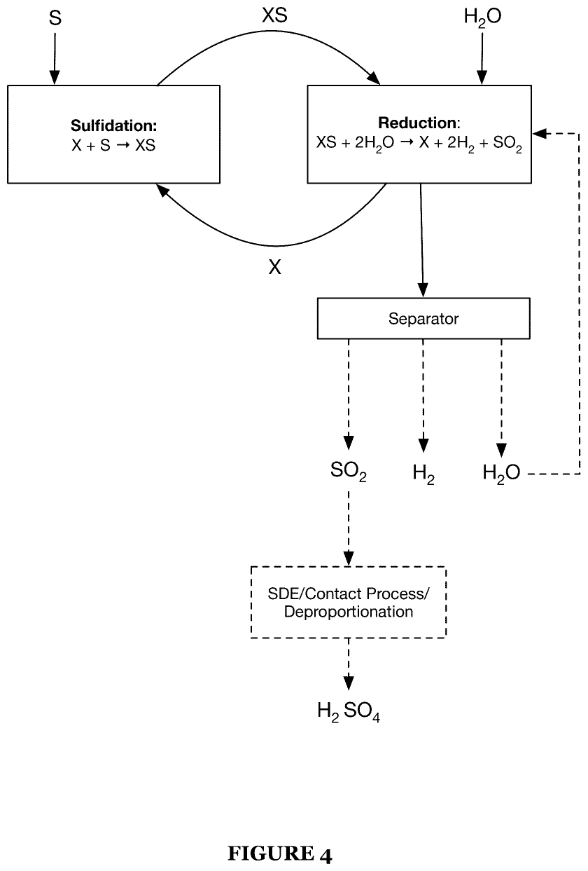

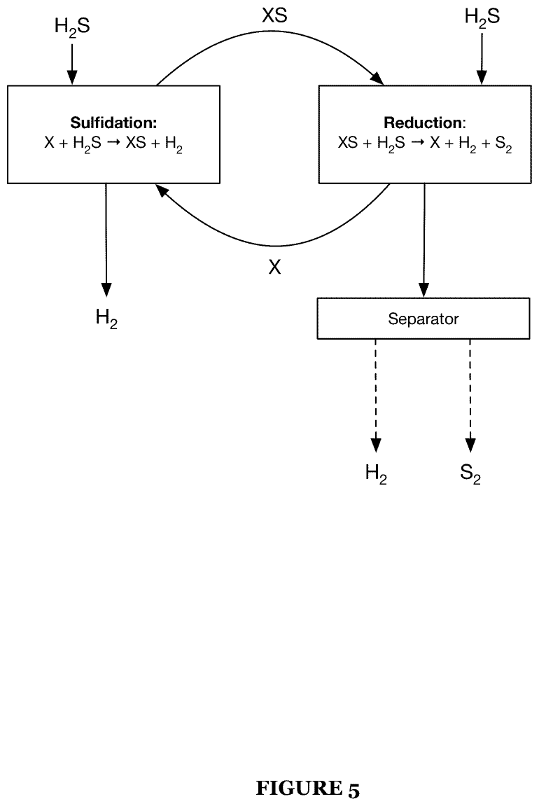

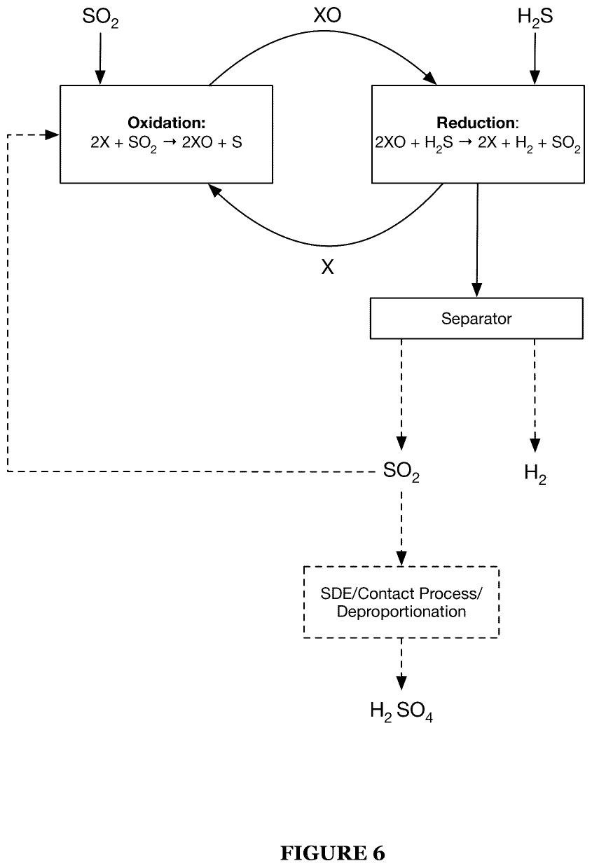

In a first example (as shown for instance in FIG. 2 or FIG. 3) of the two-step thermochemical cycle, the first reaction can include X+H₂O→XO+H₂ and the second reaction can include S+2XO→SO₂+2X; resulting in an overall reaction of 2H₂O+S→2H₂+SO₂. In a second example of the two-step thermochemical cycle, the first reaction can include X+H₂O→XO+H₂ and the second reaction can include H₂S+3XO→SO₂+3X+H₂O; resulting in an overall reaction of 2H₂O+H₂S→3H₂+SO₂. In a third example of the two-step thermochemical cycle (as shown for instance in FIG. 4), the first reaction can include X+S→XS and the second reaction can include XS+2H₂→X+2H₂+SO₂; resulting in a net reaction of S+2H₂O→2H₂+SO₂. In a fourth example of the two-step thermochemical cycle (as shown for instance in FIG. 5), the first reaction can include X+H₂S→XS+H₂ and the second reaction can include XS+H₂S→X+H₂+S₂; resulting in a net reaction of 2H₂S→2H₂+S₂. In a fifth example of the two-step thermochemical cycle (as shown for instance in FIG. 6), the first reaction can include 4X+2SO₂+4XO+S₂ and the second reaction can include 2XO+H₂S→2X+H₂+SO₂; resulting in a net reaction of 2H₂S→2H₂+S₂. In a sixth example of the two-step thermochemical cycle, the first reaction can include 2X+S+2H₂O→2XH₂+SO₂ and the second reaction can include XH₂→X+H₂; resulting in a net reaction of 2H₂O+S→2H₂+SO₂. In a seventh example of the two-step thermochemical cycle, the first reaction can include XS_{y}+H₂S→XS_{y+1}+H₂ and the second reaction can include XS_{y+1}+O₂→XS_{y}+SO₂; resulting in a net reaction of H₂S+O₂→H₂+SO₂. However, the two-stage thermochemical cycle can include other suitable reactions (e.g., including combinations of two or more of the preceding variants).

The method can include performing any of the mentioned reactions as steps in an extended thermochemical cycle (e.g., coupling two or more independent thermochemical cycles in series) and/or by linking other reactions together.

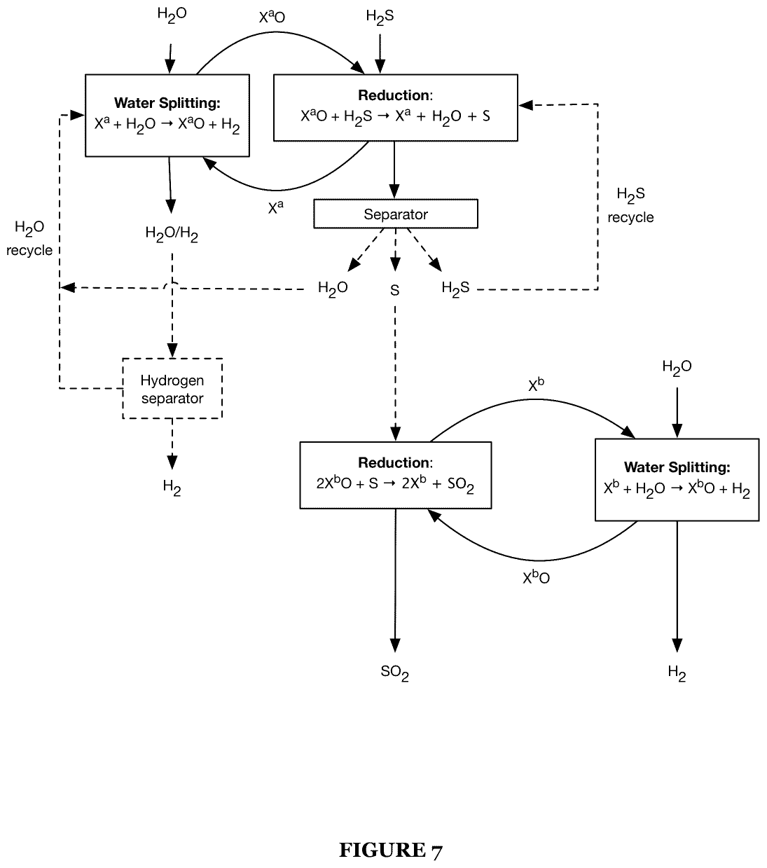

In a first variant (as shown for instance in FIG. 7), the method can include performing a first 2-step reaction (first thermochemical cycle) and a second 2-step reaction (second thermochemical cycle). In an example of the first variant, the first thermochemical cycle can include cyclically performing the reactions X^{a}+H₂O→X^{a}O+H₂ and H₂S+X^{a}O→S+X^{a}+H₂O and the second thermochemical cycle can include cyclically performing the reactions X^{b}+H₂O→X^{b}O+H₂ and S+2X^{b}O→SO₂+2X^{b}, where X^{a} and X^{b} are each a redox reactant (that can be the same or different redox reactant). In a second example of the first variant, the first thermochemical cycle can include cyclically performing the reactions X^{a}+H₂O→X^{a}O+H₂ and H₂S+3X^{a}O→SO₂+3X^{a}+H₂O and the second thermochemical cycle can include cyclically performing the reactions X^{b}+H₂O→X^{b}O+H₂ and S+2X^{b}O→SO₂+2X^{b}, where X^{a} and X^{b} are each a redox reactant (that can be the same or different redox reactant) and where the second reaction can use sulfur formed as a byproduct in the first thermochemical cycle (e.g., the second thermochemical cycle can be performed at times when sufficient sulfur byproduct build-up is accumulated). However, other coupled thermochemical cycles can be performed (often but not exclusively with a first thermochemical cycle that uses dihydrogen sulfide or an organosulfur compound as the sulfurous reagent and the second thermochemical cycle uses sulfur as the sulfurous reagent).

In a second variant, steam dihydrogen sulfide reforming (e.g., 2H₂S+4H₂O→2SO₂+6H₂) can be performed as a thermochemical cycle (e.g., cyclically performing X+H₂O→XO+H₂ and H₂S+3XO→SO₂+3X+H₂O) and can be coupled with a Claus process (4H₂S+2SO₂+3S₂+4H₂O), resulting in an overall reaction of 6H₂S→3S₂+6H₂. The second variant can be particularly beneficial for increasing an amount of hydrogen formed relative to sulfur dioxide and/or sulfuric acid.

Processing the products S300 functions to chemically modify or alter the products and byproducts of S100 and S200 (e.g., for continued use in thermochemical cycle, for use in other applications, etc.).

S300 can include processing the products and/or byproducts. S300 is preferably performed prior to repeating S100 and/or S200.

In variants, processing the products S300 includes separating gases; condensing sulfur; and processing metal sulfides.

Separating gases can function to remove undesirable species from a gaseous mixture. Separating gases can be performed by separators, scrubbers, distillation columns, membranes, absorption towers, and/or any other separation devices. The gases are preferably separated using methods that do not require cooling (e.g., to maintain heat or phase of matter of the separated products which can be beneficial for recycling the separated materials in S100 or S200). In one variant, separating gases can include separating (e.g., removing) H₂O from H₂. In a specific example, separation can be performed using a high temperature ceramic or membrane (e.g. palladium membrane, etc.), which can facilitate separation of steam from H₂ (where the steam can then be reused for hydrolysis and/or reduction reactions). However, additionally or alternatively, the gases can be separated using condensation-based separation, pressure swing adsorption, membrane separation, chemical absorption, centrifugal separation, gas-density based methods, and/or any other separation methods. In a second variant, separating gases can include separating oxygen and/or inert gases from SO₂. The separated oxygen or inert gas can be re-used in S200.

However, separating gases can be otherwise performed.

Condensing sulfur can function to separate (e.g., remove) un-reacted sulfur from a sulfur dioxide stream to be re-used (e.g., in S200). Condensing sulfur can be performed by condensers (e.g. shell and tube condensers, water cooled condensers, etc.), heat exchangers, cryogenic liquefiers, and/or any other condensing equipment.

However, condensing sulfur can be otherwise performed.

In variants in which metal-based redox reactants are used, metal sulfides can be formed. While in some variants, these can be desired species for the thermochemical cycles, this is not always the case. When the production of metal sulfides occurs, some variants of the method can include processing steps to convert the metal sulfides into the base metal or into the metal oxide (which can then be reduced via S200). For instance, S300 can include roasting metal sulfide (e.g., in an oxidizing environment). Additionally and/or alternatively, processing metal sulfides can include reacting (e.g., decomposing) metal sulfides. For instance, metal sulfides can be decomposed into metal (e.g., to be used as a redox reactant in S100) and sulfur.

However, processing the products S300 may be otherwise performed.

Using products S400 functions to leverage the outputted products (e.g., SO₂, H₂, sulfuric acid, etc.) for various applications. In variants, using products S400 can include using SO₂ to produce sulfuric acid; using hydrogen; and using sulfuric acid.

In one variant, SO₂ can be used to produce sulfuric acid via electrochemically oxidizing SO₂. The electrochemical oxidation can be performed by an electrolyzer. In a specific example, the SO₂ can be converted to H₂SO₄ electrochemically in a manner as described in U.S. patent application Ser. No. 18/598,324 titled ‘SULFUR DIOXIDE DEPOLARIZED ELECTROLYSIS AND ELECTROLYZER THEREFORE’ which was filed on 7 Mar. 2024, U.S. patent application Ser. No. 18/633,051 titled ‘SULFUR DIOXIDE DEPOLARIZED ELECTROLYSIS AND ELECTROLYZER THEREFORE’ which was filed on 11 Apr. 2024, and/or U.S. patent application Ser. No. 19/087,106 titled ‘SULFUR DIOXIDE ELECTROLYZER WITH IMPROVED SULFURIC ACID CONCENTRATION FORMATION AND METHOD OF OPERATION’ which was filed on 21 Mar. 2025 and is incorporated in its entirety by this reference.

In a second variant, SO₂ can be converted to sulfuric acid via an SO₂ disproportionation reaction. As an illustrative example, the disproportionation reaction can follow the chemical equation: 3SO₂+2H₂O→2H₂SO₄+S. The disproportionation reaction can be performed in a reaction chamber. The reaction can include using an oxidation agent or catalyst to increase reaction efficiency. The sulfur produced in SO₂ disproportionation can be reused in other steps of the method (e.g., S100, S200).

In a third variant, SO₂ can be converted to sulfuric acid via a contact process (e.g., oxidizing SO₂ into SO₃, producing oleum by dissolving SO₃ in sulfuric acid, diluting oleum to produce sulfuric acid) and/or any other process.

In a fourth variant, two or more of the preceding variants can be combined (e.g., to balance a relative concentration of sulfuric acid to total hydrogen produced). For example, sulfuric acid produced using an electrolyzer can be combined with sulfuric acid produced using the contact process such as in a manner as described in U.S. patent application Ser. No. 19/052,739 titled ‘SYSTEMS AND METHODS FOR INCREASE SULFURIC ACID CONCENTRATIONS FROM SULFUR DIOXIDE DEPOLARIZED ELECTROLYSIS AND USES THEREOF’ filed 13 Feb. 2025, which is incorporated in its entirety by this reference.

However, using SO₂ to produce sulfuric acid may be otherwise performed.

Using hydrogen functions to use hydrogen for various applications. In a first example, hydrogen can be used in a hydrogen fuel cell (e.g., to produce energy or electricity). In a second example, hydrogen can be used for one or more chemical processes (e.g., ammonia synthesis, methanol production, hydrocracking for petroleum refining, metal ore reduction, etc.). In a third example, hydrogen can be used for hydrogenation reactions. However, the hydrogen can be used for any suitable application(s).

Using sulfuric acid functions to use sulfuric acid for various applications. As a first example, sulfuric acid can be used to make phosphate fertilizer (e.g., by leaching phosphoric acid from a phosphate ore such as calcium phosphate). As a second example, sulfuric acid can be used for mineral refining (e.g., leaching, organic removal, etc.). As a third example, sulfuric acid can be used for alkylation (e.g., in petroleum refinement). However, sulfuric acid can be used for any suitable reaction(s).

However, using products S400 may be otherwise performed.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

We claim:

1. A method comprising:
within a thermal reactor, reacting a metal in a two-step reaction consisting of:
a first reaction comprising:
introducing water into the thermal reactor;
heating the thermal reactor to a temperature between 400° C. and 800° C.;
reacting the metal and the water for a first reaction time between 0.5 seconds and 5 seconds to oxidize the metal into a metal oxide and produce hydrogen; and
a second reaction comprising:
introducing sulfur into the thermal reactor;
heating the thermal reactor to a temperature between 900° C. and 1500° C.; and
reacting the metal oxide and the sulfur for a second reaction time between 0.01 seconds and 3 seconds to reduce the metal oxide back to the metal and produce sulfur dioxide; and
repeating the two-step reaction.

2. The method of claim 1, further comprising separating steam from the hydrogen using a membrane, wherein the steam is introduced into the thermal reactor during repeating the two-step reaction.

3. The method of claim 1, further comprising separating sulfur from the sulfur dioxide using a condenser, wherein the separated sulfur is introduced into the thermal reactor during repeating the two-step reaction to reduce the metal oxide.

4. A method comprising:
performing a series of reactions in a closed cycle, the series of reactions consisting of:
a hydrolysis reaction wherein a metal is oxidized to a corresponding metal oxide with water contemporaneously with the production of hydrogen; and
a reduction reaction wherein the metal oxide is reduced to the metal using a sulfurous reactant contemporaneously with production of sulfur dioxide.

5. The method of claim 4, wherein the metal oxide is a non-volatile oxide.

6. The method of claim 4, wherein the metal comprises at least one of: iron, zinc, tin, cerium, copper, manganese, vanadium, titanium, chromium, cobalt, or nickel.

7. The method of claim 4, wherein the hydrolysis reaction is performed at a temperature between 400° C. and 800° C.

8. The method of claim 4, wherein the hydrolysis reaction is performed at a pressure between 10 bar and 30 bar.

9. The method of claim 4, wherein the reduction reaction is performed at a temperature between 900° C. and 1500° C.

10. The method of claim 4, further comprising separating steam from the hydrogen using a membrane, wherein the separated steam is used when performing the hydrolysis reaction in subsequent reactions of the closed cycle.

11. The method of claim 10, wherein the membrane comprises palladium.

12. The method of claim 4, wherein the sulfurous reactant is sulfur, wherein the method further comprises separating the sulfur from the sulfur dioxide using a condenser, wherein the separated sulfur is used when reducing the metal in subsequent reactions of the closed cycle.

13. The method of claim 4, wherein the sulfurous reactant is dihydrogen sulfide, wherein the method further comprises separating the dihydrogen sulfide from the sulfur dioxide.

14. The method of claim 13, further comprising oxidizing the separated dihydrogen sulfide to sulfur via a combined thermal and catalytic process.

15. The method of claim 4, wherein the sulfurous reactant is sulfur, the method further comprising a thermochemical cycle to produce the sulfur from dihydrogen sulfide.

16. The method of claim 15, wherein the thermochemical cycle consists of:
a second hydrolysis reaction wherein a second metal is oxidized to a corresponding second metal oxide with water contemporaneously with the production of hydrogen; and
a second reduction reaction wherein the second metal oxide is reduced to the second metal using the separated dihydrogen sulfide contemporaneously with production of sulfur and water.

17. The method of claim 16, wherein the second metal is selected from the group consisting of: iron, zinc, tin, cerium, copper, manganese, vanadium, nickel, titanium, chromium, cobalt, and combinations thereof.

18. The method of claim 4, further comprising producing sulfuric acid from the sulfur dioxide, wherein producing sulfuric acid from sulfur dioxide comprises at least one of: performing sulfur dioxide disproportionation in the presence of water to produce sulfuric acid and elemental sulfur; oxidizing the sulfur dioxide using an electrolyzer; or performing a contact process.

19. The method of claim 4, wherein performing the series of reactions in the closed cycle comprises repeating the series of reactions until the metal is substantially degraded.

20. The method of claim 4, wherein oxygen is introduced into the thermal reactor during the reduction process, wherein heat for the reduction process is provided by sulfurous material combustion within the thermal reactor.
